(19) United States
(12) Patent Application Publication
(10) Pub. No.: US 2013/0088936 A1
(43) Pub. Date: Apr. 11, 2013

(54) SONAR TORPEDO COUNTERMEASURE

(71) Applicant: Siew Kok Hui, Singapore (SG)

(72) Inventor: Siew Kok Hui, Singapore (SG)

(73) Assignee: BITWAVE PTE LTD, Singapore (SG)

(21) Appl. No.: 13/645,656

(22) Filed: Oct. 5, 2012

Related U.S. Application Data
(60) Provisional application No. 61/546,001, filed on Oct. 11, 2011.

(51) Int. Cl. H04K 3/00

(52) U.S. Cl. 367/1

(57) ABSTRACT

Described herein are countermeasure techniques (both active and passive). The techniques employ a plurality of devices that can be launched to different locations. The plurality of devices at the different locations, each including a sonar transmitter and receiver, can act in concert to emulate a target of a torpedo. The emulated target contains the necessary characteristics of a legitimate target to deceive the torpedo.

### RELATED APPLICATIONS

This application claims priority to U.S. Provisional Application Ser. No. 61/546,001, filed on Oct. 11, 2011, entitled “System and Apparatus for Torpedo Sonar Countermeasure.” The entirety of the above-captioned application is incorporated herein by reference.

### TECHNICAL FIELD

This disclosure generally relates to active or passive sonar countermeasure techniques that can facilitate torpedo countermeasure.

### BACKGROUND

A modern torpedo is an underwater self-propelled weapon that contains an explosive warhead. The torpedo can be launched above or below the water surface and propelled underwater toward its target (e.g., a submarine, a surface ship or the like) and able to out maneuver targets. The ability to out maneuver a target is due the torpedo possessing a “seek and destroy capability.”

The torpedo can send out a sonar signal (e.g., a “ping”) that can be returned by a target. Active sensors on the torpedo can detect the return ping from the target, and this return ping can be used to determine the location of the target. The location tracking (or “seek”) ability of the torpedo can be improved by advanced signal processing techniques that can extract a Doppler shift caused by motion of the target from the return ping, eliminating false alarms and improving target detection and tracking. The torpedo can home in on the target and “destroy” the target. The warhead within the torpedo is designed to detonate either on contact with the target or in proximity to the target.

Pings used by a modern torpedo typically operate in a high frequency, which enables the torpedo to achieve the necessary resolution for target signal classification. The detection range of the high frequency sonar is limited because sonar signals at high frequencies experience a loss of sonar energy due to high absorption loss in seawater. Accordingly, the target will always be able to know that a torpedo has been launched against it and will have time to take actions to avoid being hit by the torpedo. These actions, including the deployment of countermeasure techniques and the performance of platform evasion, aim to deceive the torpedo so that the torpedo misses the target. Common countermeasure techniques involve jamming techniques, such as the acoustic noise generator technique and the acoustic pulse repeater technique.

The objective of the acoustic noise generator technique is to swamp the torpedo receiver with a high level of noise. With the acoustic noise generator technique, a device receives a ping from a torpedo and emits noise in response. The noise will mask the actual target, which causes the torpedo to miss the target. Countermeasure devices using the acoustic noise generator technique are low cost, but ineffective against modern torpedoes.

Devices using the acoustic pulse repeater technique are more effective, but also more expensive. The acoustic pulse repeater technique is more sophisticated than the acoustic noise generator technique, involving the use of advanced signal processing techniques. A countermeasure device employing the acoustic pulse repeater technique receives a ping from a torpedo and employs a piezo-ceramic transducer to generate a response ping that is Doppler shifted so as to emulate a moving target. Piezo-ceramic transducers need a high voltage and are highly inefficient. With limited battery power, the endurance of these devices is short.

Additionally, countermeasure devices using the acoustic noise generator technique or the acoustic pulse repeater technique are likely to fail. These devices generate point sources with no physical extent. A modern torpedo can easily discriminate the point source target from the real target that has a physical extent. Additionally, these countermeasure devices have short lifespans after launch and are unable to protect the target from multiple attacks over a period of time.

The above-described background is merely intended to provide an overview of contextual information regarding torpedo countermeasure techniques, and is not intended to be exhaustive. Additional context may become apparent upon review of one or more of the various non-limiting embodiments of the following detailed description.

### SUMMARY

The following presents a simplified summary of the specification in order to provide a basic understanding of some aspects of the specification. This summary is not an extensive overview of the specification. It is intended to neither identify key or critical elements of the specification nor delineate any scope of particular embodiments of the specification, or any scope of the claims. Its sole purpose is to present some concepts of the specification in a simplified form as a prelude to the more detailed description that is presented later.

In accordance with one or more embodiments and corresponding disclosure, various non-limiting aspects are described in connection with active or passive sonar countermeasure techniques, particularly in the field of torpedo countermeasure. Active sonar countermeasure techniques generate response pings for the torpedo with characteristics of the intended target. Passive sonar countermeasure employs noise generation to deceive the torpedo.

In an exemplary, non-limiting embodiment, a device is described that includes a mechanical acoustic transistor comprising a metal plate and a receiver comprising a piezo film. The device also includes an induction motor. The induction motor can facilitate a striking of the metal plate to produce an acoustic signal in response to the receiver detecting a ping signal from a torpedo.

In another exemplary, non-limiting embodiment, a system is described that includes a plurality of devices that can be launched from an on-board launcher to pre-designated locations. The plurality of devices can include a first device and a second device that each includes an active sonar transmitter and an ultra-sensitive receiver. The first device is configured to be launched to a first location and the second device is configured to be launched to a second location. Working in concert, the first device and the second device can emulate a target platform for a torpedo with the necessary characteristics of a legitimate target that can deceive the torpedo.

In a further exemplary, non-limiting embodiment, a method is described that can facilitate torpedo countermeasure. A method includes receiving a ping from a torpedo directed to a target by a system including a processor. In response to receiving the ping, the system can emulate the target by launching a first device comprising a first active sonar transmitter to a first location and a second device comprising a second active sonar transmitter to a second location. Acting in concert, the first device and the second device can emulate the target with the necessary characteristics of a legitimate target so as to deceive a torpedo.

In the active countermeasure mode, the first device and the second device can work in concert to re-transmit the ping to the torpedo to facilitate deception of the torpedo. In the passive countermeasure mode, the first device and the second device can generate a noise signal to emulate the platform noise of the target to deceive the torpedo.

The following description and the drawings set forth certain illustrative aspects of the specification. These aspects are indicative, however, of but a few of the various ways in which the various embodiments of the specification may be employed. Other aspects of the specification will become apparent from the following detailed description of the specification when considered in conjunction with the drawings.

### BRIEF DESCRIPTION OF THE DRAWINGS

Numerous aspects and embodiments are set forth in the following detailed description, taken in conjunction with the accompanying drawings, in which like reference characters refer to like parts throughout, and in which:

FIG. 1 is a schematic illustration of a system that can generate of an acoustic signal to facilitate sonar torpedo countermeasure techniques, according to a non-limiting embodiment;

FIG. 2 is a schematic illustration of an example metal plate that can be utilized to facilitate generation of an acoustic signal, according to a non-limiting embodiment;

FIG. 3 is a schematic illustration of an example array of metal plates that can facilitate sonar torpedo countermeasure techniques, according to a non-limiting embodiment;

FIG. 4 is a schematic illustration of an example mechanical transducer that can be utilized to facilitate generation of an acoustic signal, according to a non-limiting embodiment;

FIG. 5 is a schematic illustration of an example launcher illustrating devices firing in salvo, according to a non-limiting embodiment;

FIG. 6 is a schematic illustration of an example of the devices launched in such a way that they emulate an extended realistic target, according to a non-limiting embodiment;

FIG. 7 is a process flow diagram of a method that can facilitate a countermeasure technique, according to a non-limiting embodiment;

FIG. 8 is a process flow diagram of a method that can facilitate emulation of a realistic target, according to a non-limiting embodiment;

FIG. 9 is a process flow diagram of a method that can emulate a target according to four devices, according to a non-limiting embodiment;

FIG. 10 is a process flow diagram of a method that can produce a countermeasure in response to detection of a torpedo signal, according to a non-limiting embodiment;

FIG. 11 is a schematic block diagram of an example computing environment; and

FIG. 12 is a schematic block diagram of an example networking environment.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that the certain aspects of disclosure may be practiced without these specific details, or with other methods, components, molecules, etc. In other instances, well-known structures and devices are shown in block diagram form to facilitate description and illustration of the various embodiments.

In accordance with one or more embodiments, described herein are various systems and methods relating to torpedo sonar countermeasure. The various systems and methods can emulate a target of a torpedo by launching a plurality of devices, each including a sonar transmitter, to different locations. The plurality of devices can act in concert to emulate the target to facilitate deception of the torpedo.

The various systems and methods solve the point source issue, the target spatial extent and the endurance issue faced by conventional sonar countermeasure systems. Additionally, the sonar transmitters employed by the devices are mechanical in structure and extremely reliable, allowing the devices to be launched from a launcher to the designated location only when required. Accordingly, several sets of devices with their individual systems can be kept on standby basis to tackle multiple torpedoes simultaneously.

Utilization of the various exemplary, non-limiting embodiments presented herein can facilitate (in a non-limiting list):

a) denial of detection by a sonar system, particularly the sonar of a torpedo;

b) deception of a sonar system, particular the sonar of a torpedo;

c) generation of realistic platform noise and/or ping with realistic Doppler shift to emulate a realistic platform echo of a target; and

d) emulation of a target with spatial extent.

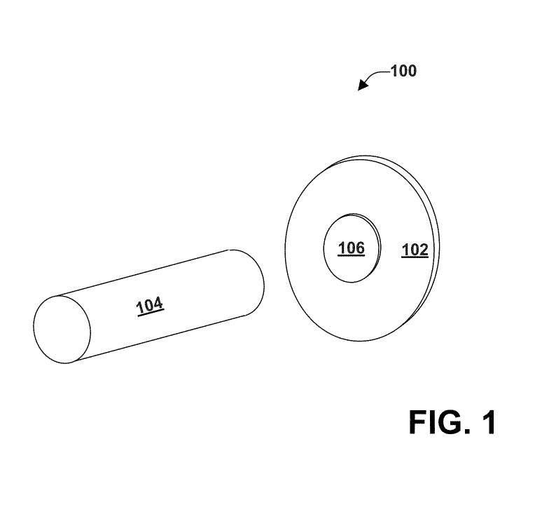

Referring now to the drawings, with reference initially to FIG. 1, illustrated is an exemplary, non-limiting embodiment of a system 100 that facilitates torpedo sonar countermeasure. The system 100 can be embodied in a device that can be used in concert with other devices to deny detection of a target by a sonar system of a torpedo by deception of the sonar system through emulating a target with spatial extent and generating a realistic platform noise and/or ping with realistic Doppler shift to emulate a realistic platform echo of a target. It is to be appreciated that, while the various exemplary non-limiting embodiments presented herein relate to torpedo sonar countermeasure, the various embodiments are not so limited and are applicable to any situation in which the various conditions and factors presented herein are suitable to facilitate countermeasure.

Instances of system 100 can be housed in different devices to facilitate the countermeasure. The device can launch in salvo (or at the same time or almost at the same time) with at least one other device to emulate the target with spatial extent to deceive a torpedo's sonar system. A wireless network chip or any other computing device (e.g., a computer with a hardware processor) can also be included in system 100 so that the devices, when launched in salvo, can be coordinated so as to emulate the realistic target.

System 100 utilizes low cost, simple components to facilitate generation of the countermeasure signal. Instead of a piezo-ceramic transducer as used by conventional countermeasure devices, system 100 employs a mechanical acoustic transducer that includes a metal plate 102 rather than a ceramic. The metal plate 102 can be constructed from any type of metal, metal alloy, composite, or a combination thereof. In an embodiment, the metal plate 102 can be constructed from nickel, copper or aluminum. In another embodiment, the metal plate 102 includes aluminum. When the metal plate 102 is made of aluminum, it is resistant to the environment (e.g., resistant to the effects of salt water, such as corrosion) so it is well suited to be used in underwater applications, such as a sonobuoy.

The transistor can also include a receiver. The receiver can be, in an embodiment, piezoelectric film sensor or “piezo film.” The term “piezo film” generally refers to any thin film device that operates according to piezoelectric effect technology to facilitate acoustic signal detection and transmission. The piezo film sensor can be of any size or shape, and can be attached to the metal plate 102 in any way to facilitate detection of a ping signal from a torpedo to facilitate the countermeasure process.

The acoustic signal is generated when metal plate 102 is excited by an external force (e.g., through striking the metal plate 102 to produce acoustic resonance). System 100 includes an induction motor 104 that can excite the metal plate 102 to facilitate generation of an acoustic signal. For example, the induction motor 104 can facilitate striking of the metal plate 102 to produce resonance and generate the acoustic signal. In an embodiment, the induction motor 104 can be attached to the metal plate 102 to facilitate the striking. The acoustic signal produced by striking the metal plate 102 is powerful and efficient so that it is suitable for acoustic countermeasures against a torpedo (e.g., a torpedo employing advanced homing sonar).

Various kinds of acoustic signals with different power levels can be generated using this technique. One type of acoustic signal imitates platform noise of a target. Another type of acoustic signal imitates a response ping with realistic Doppler shift to emulate a realistic platform echo of a moving target. The choice of the acoustic signal can be based on a tactical decision of the user.

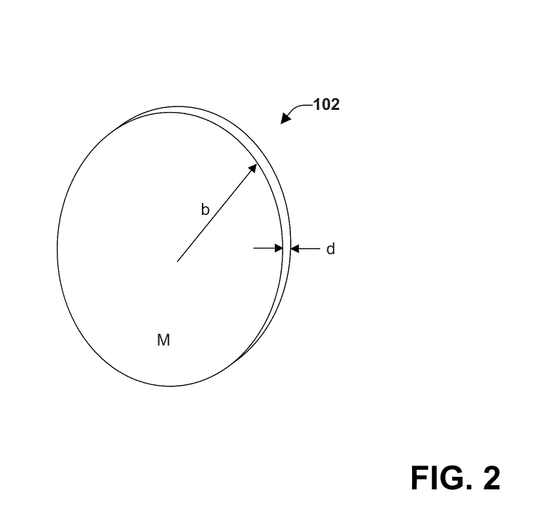

The type of acoustic signal produced (e.g., different power level) can be based on the frequency response of the metal plate 102. The metal plate 102 can be designed such that the resonant frequency of the plate can be tailored to a specific characteristic of the acoustic signal (e.g., power level, frequency, or the like). FIG. 2 illustrates a number of parameters that can be considered in the design of the metal plate 102 to tailor the resonant frequency and specific acoustic signal. Parameters that influence the frequency response of the metal plate 102 include radius of the plate (b), thickness of the plate (d), mass of the plate (M), and/or density of the material(s) used to construct the plate. For example, the induction motor 104 can strike the metal plate 102 and cause the metal plate 102 to resonate at a natural frequency of the metal plate 102 and produce an acoustic signal. It is to be appreciated that while the various exemplary embodiments presented herein are described with reference to the induction motor 104 striking the metal plate 102, the induction motor 104 can facilitate excitation of the metal plate 102 in another way that does not include striking. For example, referring back to FIG. 1, the induction motor 104 can facilitate the metal/motor interface 106 striking the metal plate 102 to excite the metal plate. In an embodiment, the metal/motor interface can be utilized to dampen the resonance.

In an exemplary, non-limiting embodiment, it is preferable that the resonant frequency be chosen to reside at the highest possible frequency region separate from operating noises of apparatuses employing system 100 (e.g., target apparatuses). Operating noise (e.g., engine noise, etc.) is typically dominant at the low frequency region of the acoustic spectrum, and hence, plate 102 can be designed to produce resonance at a higher frequency further away from the operating noise end of the spectrum. Moreover, since the ping received from the torpedo is generally at a high frequency, it is important to re-ping the torpedo with a similarly high frequency re-ping.

Further, the resonant sensor associated with metal plate 102 is characterized by a high quality factor Q that further enables it to reject operating noise outside of its bandwidth. By having a high Q a lower rate of energy loss occurs relative to the stored energy of the metal plate 102. Thus, the oscillations set up in plate 102 due to excitation by the induction motor 104, result in the oscillations in metal plate 102 dying out at a slower rate than for a plate having a low Q. Hence, in a system 100 comprising a plate 102 having a high Q, operating noise and other types of noise are unlikely to cause plate 102 to resonate.

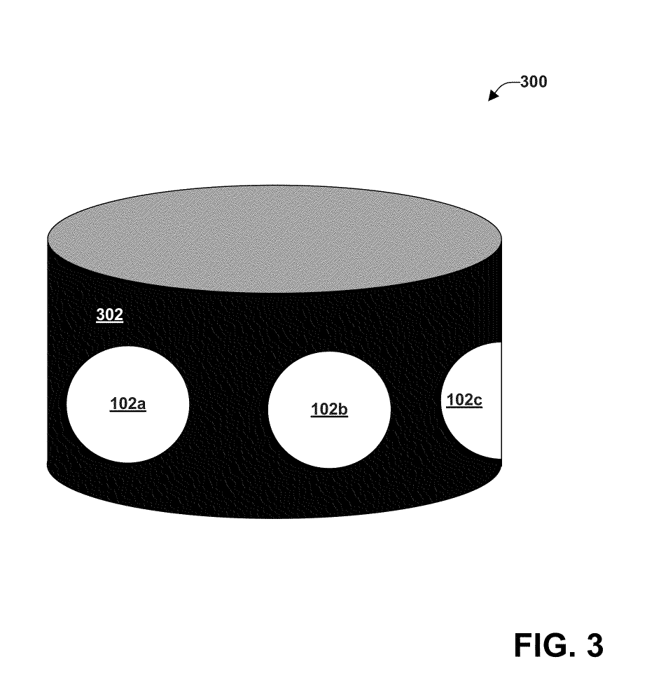

As illustrated in FIG. 3, a plurality of metal plates 102a-c can be embedded into or otherwise incorporated into a support structure 302 to form an array (akin to an omnidirectional microphone or hydrophone array) to provide a desired degree of coverage. It will be understood that although three metal plates 102a-c are illustrated, any number of metal plates can be embedded into support structure 302. In fact, a total of two metal plates embedded around the cylinder are adequate to provide 360 degrees of coverage. Additionally, although the support structure 302 is illustrated as a cylinder, it will be understood that the support structure can take any shape (two-dimensional or three-dimensional) to facilitate formation of an array of metal plates 102a-c of any geometry.

In an embodiment, the array of metal plates 102a-c can be constructed in any arrangement comparable to the aforementioned microphone or hydrophone array. In an associated embodiment, an array of metal plates 102a-c can be constructed with a configuration to facilitate construction of an array that facilitates beamforming. Beamforming can facilitate enhancement of the detection of acoustic signals, such as a ping from a torpedo, and enable determination the location of the torpedo. In an alternative configuration, a widely spaced linear array of two or more metal plates 102a-c can be combined in any geometric configuration.

The metal plates 102a-c can be embedded in (or incorporated on) a support structure 302. The support structure 302As illustrated in FIG. 3, support structure 302 can generally prevent mechanical vibrations that would cause the mechanical plates 102a-c to vibrate and/or resonate. The support structure has a profile designed to facilitate reduction in outside sources of noise and to facilitate good dynamic properties.

The metal plates 102a-c can be constructed from any material that is not ceramic. For example, the metal plate 102a-c can be constructed from any type of metal, metal alloy, composite, or a combination thereof. In an embodiment, the metal plates 102a-c can be constructed from nickel, copper or aluminum. In another embodiment, the metal plates 102a-c includes aluminum. When the metal plates 102a-c are made of aluminum, it is resistant to the environment (e.g., resistant to the effects of salt water, such as corrosion) so it is well suited to be used in underwater applications, such as a sonobuoy.

Support structure 302 can be constructed from any suitable material which can act to dampen mechanical vibrations received from any source. The material of the support structure 302 can include steel, a steel composite, metal matrix composite, composite, or the like.

The support structure 302 can be constructed so that it isolates the plurality of metal plates 102a-c from vibration (e.g., of the housing of the support structure 302). For example, the inside of the support structure 302 can be water tight and/or pressurized onto the plurality of metal plates 102a-c on the outside of the support structure 302.

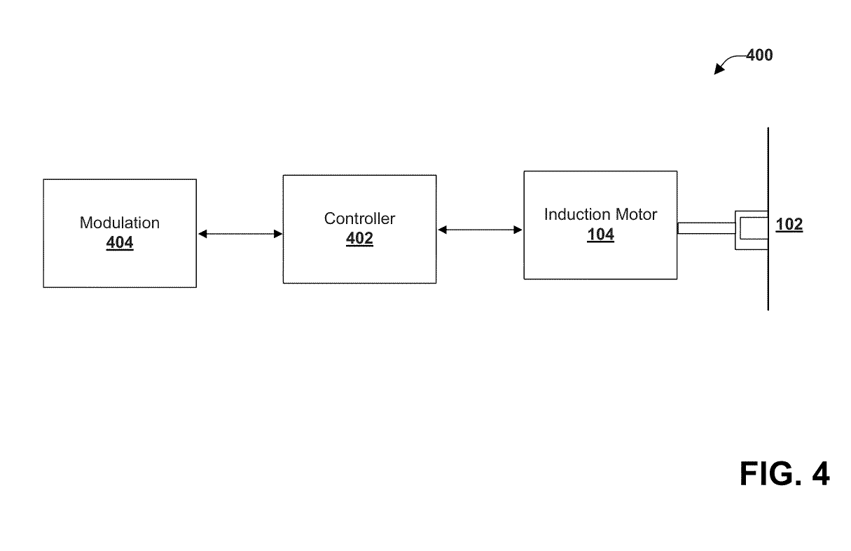

Referring now to FIG. 4, illustrated is a schematic illustration of an example mechanical transducer 400 that can be utilized to facilitate generation and transmission of an acoustic signal (e.g., a high power acoustic signal with various characteristics). The mechanical transducer 400 includes a metal plate 102 that can be driven by an induction motor 104 (e.g., a linear induction motor) to facilitates excitation/resonance of the metal plate 102. For example, the induction motor 104 can facilitate striking the metal plate 102 to facilitate resonance and eventual production of the auditory signal.

The induction motor is controlled by controller 402. In an embodiment, the controller 402 is a motor controller that can include a power source, a memory and a processor. The controller 402 can facilitate the induction motor 104 exciting the metal plate 102 in response to detection of a ping from a torpedo. The ping can be detected and registered, for example, through a digital signal processor, amplified and further modulated 404 by any number of means. The detection of the ping triggers the performance of various countermeasure techniques.

The acoustic signals are controlled and generated by the digital signal processor, which forms part of the overall system. The wireless links that are used to coordinate a group of devices to deceive the torpedo also form part of the overall mechanical transducer 400.

A device illustrated in FIG. 4 can be grouped into a system with at least one other device. The at least two devices can coordinate (e.g., through a wireless transmitter or other computing device) to work in combination to deceive the torpedo.

The at least two devices included in the system can each including an active sonar transmitter (e.g., a metal plate excited by an induction motor to transmit and acoustic signal) and a receiver (e.g., a sensor and signal processing capability). The at least two devices can each be launched to a respective location upon detection of a ping from a torpedo. At the respective locations, the devices can coordinate to re-ping the torpedo with an acoustic signal emulating a target platform of a torpedo.

A minimum of two devices are necessary to achieve 360 degrees of coverage to facilitate denial of detection by a torpedo sonar system. The deception can be active deception or passive deception by generation of realistic platform noise (passive) and/or realistic Doppler shift (active) to emulate a realistic platform echo of a target through emulation of a target with spatial extent.

In an embodiment, the system can include three devices, each including an active sonar transmitter and a receiver (e.g., including the systems as illustrated in FIGS. 1-4), that can each be launched to a respective location to emulate a target platform of a torpedo. In another embodiment, each including an active sonar transmitter and a receiver (e.g., including the systems as illustrated in FIGS. 1-4), that can each be launched to a respective location to emulate a target platform of a torpedo. Three or four devices launched to three or four respective locations help to facilitate denial of detection by a torpedo sonar system through deception by generation of realistic platform noise and/or ping with realistic Doppler shift to emulate a realistic platform echo of a target through emulation of a target with spatial extent.

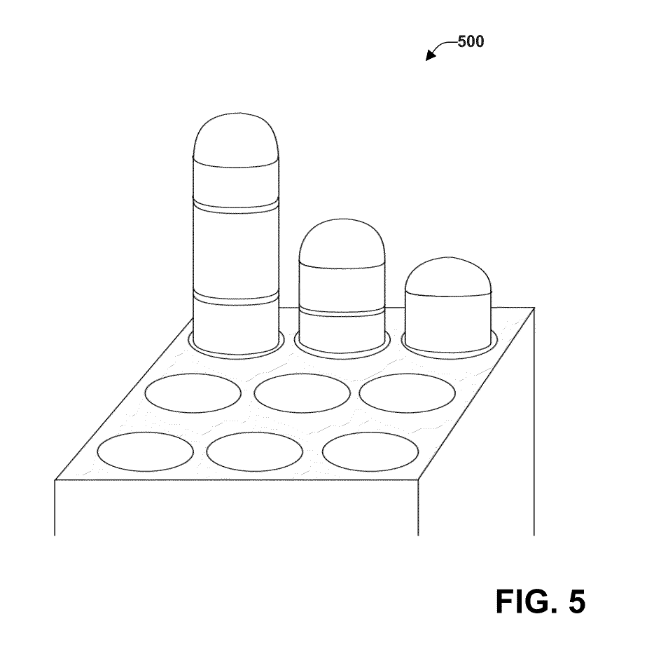

The system can include a plurality of launchable devices that can be launched from an on-board launcher 500 (as shown in FIG. 5) to pre-designated or pre-defined locations. The locations can be saved according to a pattern in a memory of a computer and retrieved upon receiving a ping from a torpedo. The locations can also be generated and/or defined just before the devices are launched instead of retrieved from a saved location to assure that the same countermeasure is not used twice.

The devices can fire in salvo (at the same time or around the same time). Although three devices are shown firing from launcher 500, it will be understood that launcher 500 can facilitate the launch of any number of devices of at least two. Additionally, it will be further understood that the devices can of any configuration. Additionally, the launcher 500 or the device can include an onboard computer that can facilitate an in salvo (at the same time or near the same time) launch of the devices.

Acting in concert (in either active mode or passive mode), the devices can emulate a target with the necessary characteristics of a legitimate target to deceive a torpedo (such as a homing torpedo). To emulate the legitimate target, the devices launched by launcher 500 each include an active sonar transmitter and a receiver. The devices can work in concert with each other to facilitate creation of a countermeasure for a torpedo. The countermeasure employed by the devices, in the passive mode, can emulate a target platform of the torpedo with spatial extent with a noise signal. In the active mode, the countermeasure employed by the devices can re-transmit a ping to the torpedo, upon receiving a ping, with a signal including realistic Doppler shift to emulate a realistic platform echo of a target through emulation of a target with spatial extent.

The active sonar transmitter and receiver in each device are mounted on (or encased within) a housing. The housing, according to an embodiment, can be unique for each device, as illustrated in FIG. 5 (e.g., one transmitter and one receiver per housing). However, it will be understood that the housing need not be unique (e.g., as shown in FIG. 3). The housing can be made of any material, including wood, metal (e.g., steel), composite, plastic, or any combination thereof. The housing isolates the sonar transmitter and the receiver from external vibrations. Additionally, the housing can be watertight. In an embodiment, the housing can include a pressure inside that is equal to the water pressure outside the housing.

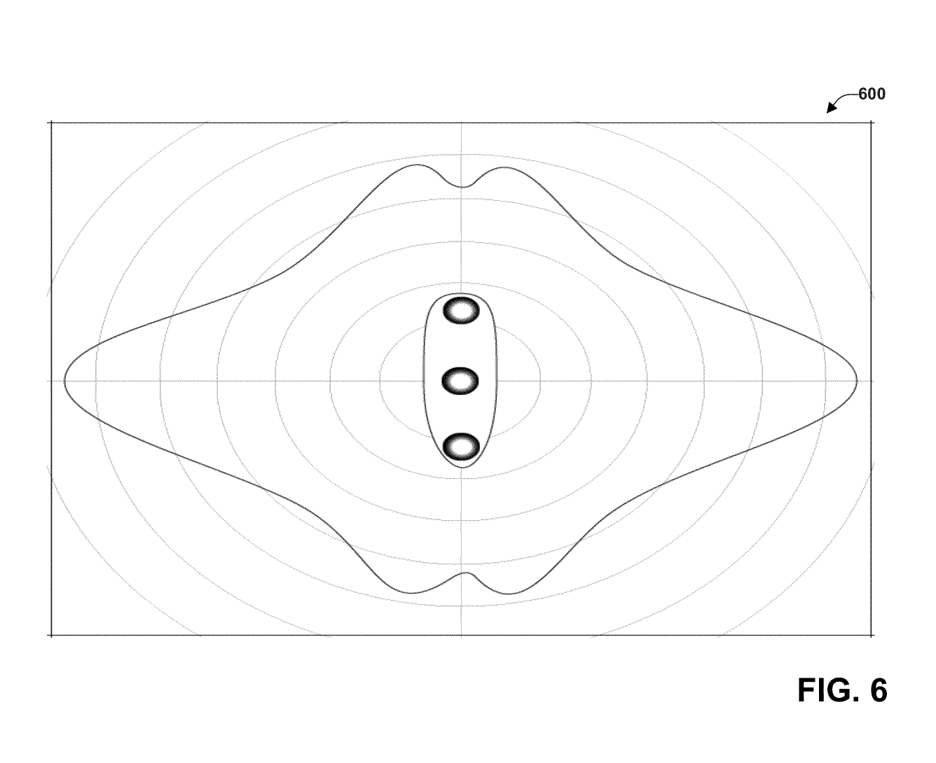

Upon sensing a ping, the launcher 500 sends the devices to their associated locations. Referring now to FIG. 6, illustrated is a schematic diagram 600 of the location of each of the launched devices in launcher 500 shown in FIG. 5. The three devices shown in FIG. 5 have landed in three different locations (shown as circles in FIG. 6) and work together to emulate an extended realistic target (shown as an oblong oval in FIG. 6, representing a boat). The circles in FIG. 6 correspond to the bow, the stern and the beam of the emulated target.

In this example, the power of the signals for the stern, the bow and the beam are distributed like a real target due, at least partially, to the positioning of the devices. For example, the signal from the beam (middle circle) can have more power (e.g., Tx Power 35 dB) than the signals from the bow and the stern (e.g., each with a Tx Power of 25 dB) to create the realistic emulated target.

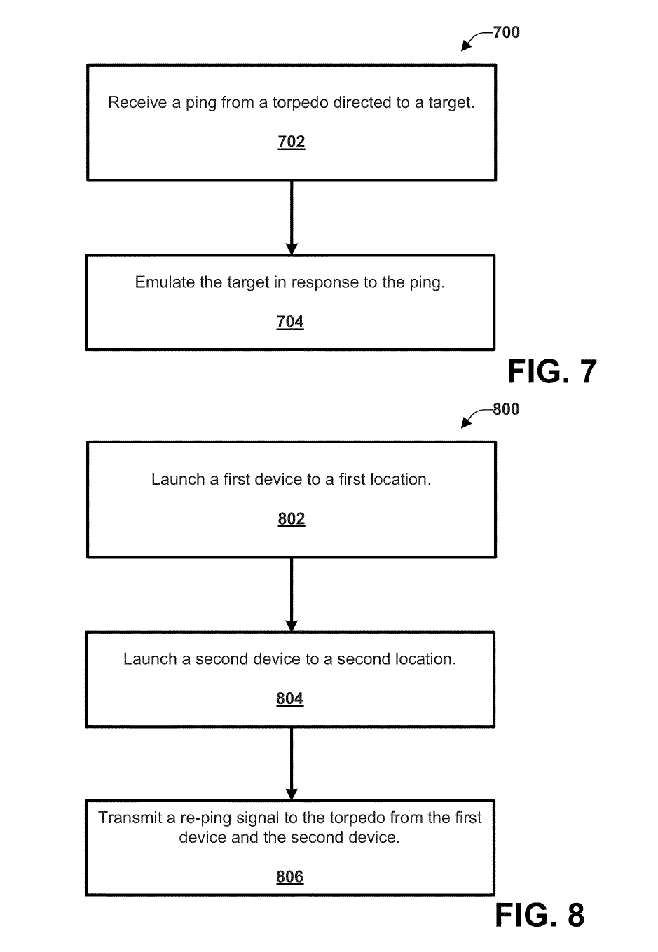

FIGS. 7-10 show methods illustrated as flow diagrams, in accordance with one or more embodiments of the subject application. For simplicity of explanation, the methods are depicted and described as series of acts. However, the methods are not limited by the acts illustrated and by the order of the acts. For example, acts can occur in various orders and/or concurrently, and with other acts not presented and described herein. Furthermore, not all illustrated acts may be required to implement the methods. The acts of the methods can be performed by a system including a processor.

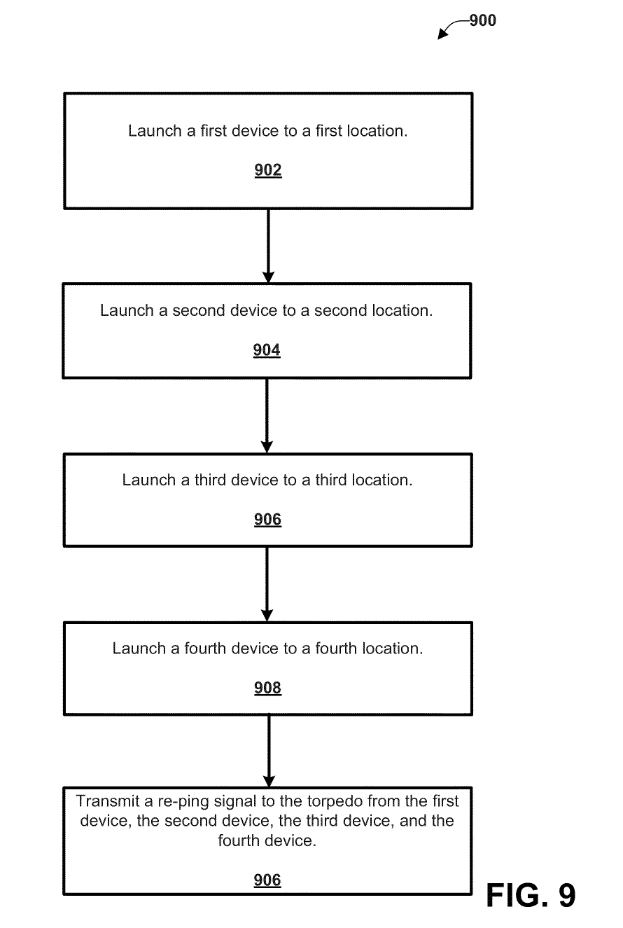

Referring now to FIG. 7, illustrated is a method 700 that can facilitate a countermeasure technique. At element 702, a ping indicating a target is received from a torpedo. At element 704, a countermeasure technique can be employed that facilitates emulating the target in response to the ping. The emulated target contains the necessary characteristics of a legitimate target to deceive the torpedo. Examples of the process for emulating the target are shown further in FIGS. 8 and 9.

Referring now to FIG. 8, illustrated is a process flow diagram of a method 800 that can facilitate emulation of a realistic target. The “realistic” target exhibits a spatial extent through positioning of at least two devices at different corresponding locations.

The method 800 can be executed by a system including a processor. The system facilitates the deployment of a plurality of devices to different locations. The devices each include a sonar transmitter. Optionally, the devices can also include a receiver and/or signal processing circuitry.

At element 802, a first device can be launched to a first location. At element 804, a second device can be launched to a second location. The first device and the second device can be launched in salvo (at the same time or near the same time) and can work in concert to emulate the target. The devices can include a wireless communications device to facilitate the devices working in concert.

At element 806, a re-ping signal can be transmitted to the torpedo from the first device and the second device. The re-ping signal (or re-ping signals sent in salvo from the devices) helps to facilitate denial of detection by a torpedo sonar system through deception by generation of realistic platform noise and/or ping with realistic Doppler shift to emulate a realistic platform echo of a target through emulation of a target with spatial extent.

Referring now to FIG. 9, illustrated is a process flow diagram of a method 900 that can emulate a target according to four devices (although the functionalities of four devices are illustrated, method 900 is able to be performed with only three devices). The method can be executed by a system that includes a processor. The system facilitates the deployment of at least three devices to different locations. The devices each include a sonar transmitter. Optionally, the devices can also include a receiver and/or signal processing circuitry.

At element 902, a first device can be launched to a first location. At element 904, a second device can be launched to a second location. At element 906, a third device can be launched to a third location. At element 908, a fourth device can be launched to a fourth location. The first device, the second device, the third device, and the fourth device can be launched in salvo (at the same time or near the same time) and can work in concert to emulate the target.

At element 910, a re-ping signal can be transmitted to the torpedo from the first device, the second device, the third device, and the fourth device. The re-ping signal (or re-ping signals sent in salvo from the devices) helps to facilitate denial of detection by a torpedo sonar system through deception by generation of realistic platform noise and/or ping with realistic Doppler shift to emulate a realistic platform echo of a target through emulation of a target with spatial extent.

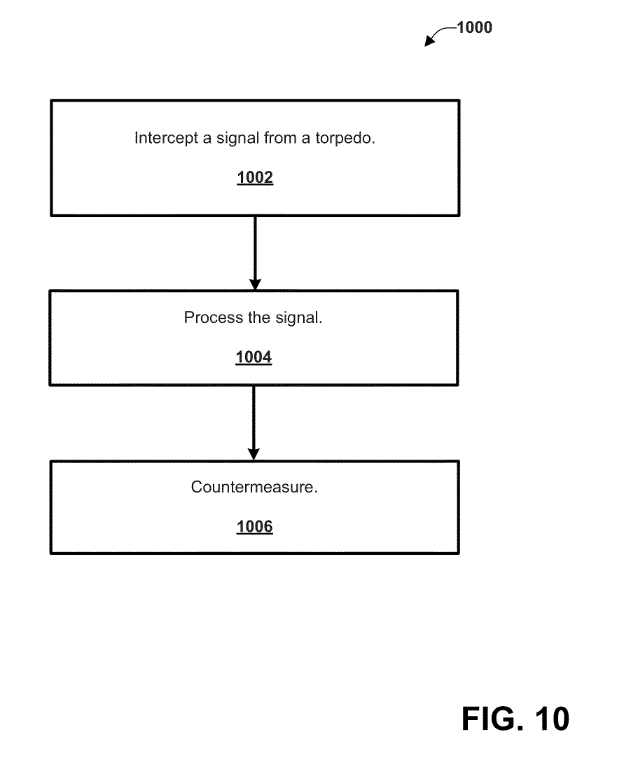

Referring now to FIG. 10, illustrated is a process flow diagram of a method 1000 that can produce a countermeasure in response to detection of a torpedo “ping” signal. At element 1002, a ping (or homing) signal can be intercepted from a torpedo. The ping can be intercepted by one or more receivers that are part of one or more devices. The devices each also include at least a transmitter in addition to the receiver. Each device has an associated transmitter. A system of multiple devices need have only one receiver, by the individual devices can also have their own receiver.

At element 1004, the ping signal can be processed. For example, the ping signal can be processed by amplifying the detected ping signal and/or digitizing the detected ping signal. The ping signal can be further processed by classifying the signal and/or determining whether the signal is a false alarm.

At element 1006, a countermeasure technique can be put in place. The countermeasure technique can include any technique that can facilitate emulating a target. For example, the emulating can be accomplished through launching two or more devices to two or more locations create a realistic target. The realistic target is created with spatial extent to deceive the torpedo.

The devices can be launched to act in a concerted effort to deceive the torpedo. For example, the devices can each include a wireless link to other devices within a network to facilitate the concerted effort. The devices can be launched in salvo (at the same time or about the same time) controlled by an on-board computer, which can optimize the launching to ensure the in salvo launch.

Upon reaching the designated locations, the devices can feed a modulation signal to the induction motor. The induction motor can facilitate excitation of a metal plate. When excited, the metal plate can resonate and produce an auditory signal, which can be transmitted in salvo with the auditory signal created by the other devices to facilitate the deception of the torpedo by emulating an extended realistic (more extent than simply a point) target.

The auditory signals from the devices can be used as a re-ping signal (or re-ping signals sent in salvo from the devices) helps to facilitate denial of detection of a target by a torpedo sonar system through deception by generation of realistic platform noise and/or ping with realistic Doppler shift to emulate a realistic platform echo of a target through emulation of a target with spatial extent.

Embodiments, systems, and devices described herein, as well as operational environments in which various aspects set forth in the subject specification can be carried out, can include computer or network components such as servers, clients, controllers (e.g., motor controller), communications modules, mobile computers, wireless components, control components and so forth which are capable of interacting across a network. Computers and servers include one or more processors-electronic integrated circuits that perform logic operations employing electric signals-configured to execute instructions stored in media such as random access memory (RAM), read only memory (ROM), a hard drives, as well as removable memory devices, which can include memory sticks, memory cards, flash drives, external hard drives, and so on.

Similarly, the term controller as used herein can include functionality that can be shared across multiple components, systems, and/or networks. As an example, one or more automation controllers can communicate and cooperate with various network devices across the network, wherein the network can be confined to an on-board configuration incorporated into the platform of interest (e.g., a countermeasure device) or the network can comprise an extended system comprising one or more countermeasure devices, and the like. This can include substantially any type of control, communications module, computer, Input/Output (I/O) device, sensor, actuator, and human machine interface (HMI) that communicate via the network, which includes control, automation, and/or public networks.

The network can include public networks such as the internet, intranets, automation networks, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

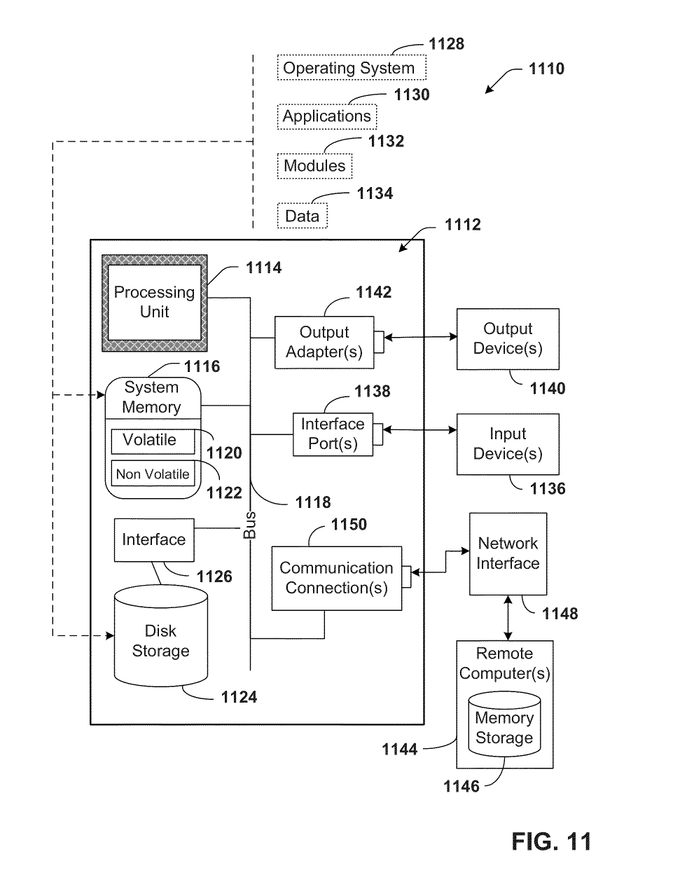

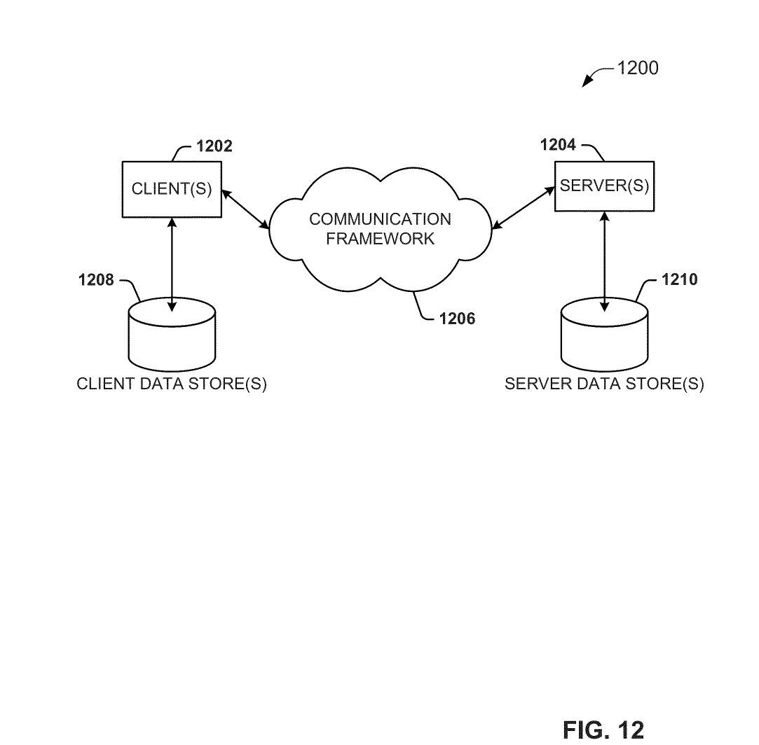

In order to provide a context for the various aspects of the disclosed subject matter, FIGS. 11 and 12, as well as the following discussion, are intended to provide a brief, general description of a suitable environment in which the various aspects of the disclosed subject matter may be implemented.

With reference to FIG. 11, an example environment 1110 for implementing various aspects of the aforementioned subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable PROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users (e.g., a pilot) and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that one or more embodiments of the subject disclosure can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, WiFi adapters, ISDN adapters, and Ethernet cards.

FIG. 12 is a schematic block diagram of a sample-computing environment 1200 with which the disclosed subject matter can interact. The system 1200 includes one or more client(s) 1210. The client(s) 1210 can be hardware and/or software (e.g., threads, processes, computing devices). The system 1200 also includes one or more server(s) 1230. The server(s) 1230 can also be hardware and/or software (e.g., threads, processes, computing devices). The servers 1230 can house threads to perform transformations by employing one or more embodiments as described herein, for example. One possible communication between a client 1210 and a server 1230 can be in the form of a data packet adapted to be transmitted between two or more computer processes (e.g., a process running on the controller 402 and a process running on the detector).

System 1200 includes a communication framework 1250 that can be employed to facilitate communications between the client(s) 1210 and the server(s) 1230. The client(s) 1210 are operably connected to one or more client data store(s) 1220 that can be employed to store information local to the client(s) 1210. Similarly, the server(s) 1230 are operably connected to one or more server data store(s) 1240 that can be employed to store information local to the servers 1230.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removably affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

What has been described above includes examples of the embodiments of the subject disclosure. It is, of course, not possible to describe every conceivable combination of components or methods for purposes of describing the claimed subject matter, but it is to be appreciated that many further combinations and permutations of the various embodiments are possible. Accordingly, the claimed subject matter is intended to embrace all such alterations, modifications, and variations that fall within the spirit and scope of the appended claims. While specific embodiments and examples are described in this disclosure for illustrative purposes, various modifications are possible that are considered within the scope of such embodiments and examples, as those skilled in the relevant art can recognize.

In addition, the words “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while an aspect may have been disclosed with respect to only one of several embodiments, such feature may be combined with one or more other features of the other embodiments as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A device, comprising:
a mechanical acoustic transducer comprising a metal plate; and
an induction motor,
wherein the induction motor facilitates excitation of the metal plate to produce an acoustic signal.

2. The device of claim 1, wherein the acoustic signal facilitates an acoustic countermeasure against a torpedo.

3. The device of claim 1, wherein the metal plate comprises nickel, copper or aluminum.

4. The device of claim 1, wherein the metal plate comprises aluminum.

5. The device of claim 1, wherein the device is launched to a first location to facilitate an acoustic countermeasure against a torpedo.

6. A system, comprising:
a first device comprising:
a first active sonar transmitter; and
a first receiver; and
a second device comprising:
an active sonar transmitter; and;
a second receiver,
wherein the first device is configured to be launched to a first location and the second device is configured to be launched to a second location to emulate a target platform of a torpedo.

7. The system of claim 6, further comprising a third device, comprising:
a third active sonar transmitter; and
a third receiver,
wherein the third device is configured to be launched to a third location in salvo with the first device and the second device to emulate the target platform of the torpedo.

8. The system of claim 6, wherein the first device and the second device are configured to emulate the target platform of the torpedo with noise.

9. The system of claim 6, wherein the first active sonar transmitter is mounted on a first housing and the second active sonar transmitter is mounted on a second housing.

10. The system of claim 9, wherein the first housing or the second housing comprises wood, steel or plastic.

11. The system of claim 9, wherein the first active sonar transmitter or the second active sonar transmitter is isolated from vibrations of the first housing and the second housing.

12. The system of claim 9, wherein the first housing or the second housing is watertight.

13. The system of claim 12, wherein a water pressure on the first housing or the second housing is equal to a pressure inside the first housing or the second housing.

14. A method, comprising:
receiving, by a system including a processor, a ping from a torpedo directed to a target; and
emulating the target, by the system, in response to the receiving the ping by launching a first device comprising a first active sonar transmitter to a first location a second device comprising a second active sonar transmitter to a second location.

15. The method of claim 14, further comprising re-transmitting, by the system, the ping from the first device and the second device to facilitate deception of the torpedo.

16. The method of claim 14, further comprising generating a noise signal to emulate platform noise of the target to deceive the torpedo.

17. The method of claim 14, wherein the emulating further comprises sending, by the system, a first acoustic countermeasure signal from the first device and a second acoustic countermeasure signal from the second device in salvo.

18. The method of claim 14, wherein the emulating further comprises launching a third device comprising a third active sonar transmitter to a third location.

19. The method of claim 18, wherein the emulating further comprises launching a fourth device comprising a fourth active sonar transmitter to a fourth location.

20. The method of claim 18, wherein the emulating further comprises sending, by the system, a first acoustic countermeasure signal from the first device and a second acoustic countermeasure signal from the second device, a third acoustic countermeasure signal from the third device and a fourth acoustic countermeasure signal from the fourth device in salvo.
